(19) United States
(12) Patent Application Publication
(10) Pub. No.: US 2022/0338661 A1
(43) Pub. Date: Oct. 27, 2022

(54) PORTABLE SELF-CONTAINED BEVERAGE BREWING APPARATUS AND METHODS OF USE

(71) Applicant: Robert J. BECKER, Guyton, GA (US)

(72) Inventor: Robert J. BECKER, Guyton, GA (US)

(21) Appl. No.: 17/241,291

(22) Filed: Apr. 27, 2021

(51) Int. Cl. A47J 31/00; A47J 31/40; A47J 31/46; A47J 31/44

(52) U.S. Cl. CPC A47J 31/005; A47J 31/407; A47J 31/461; A47J 31/4407

(57) ABSTRACT

A portable self-contained beverage brewing apparatus and methods of use to brew a beverage using a brewing cup, utilizing an inner container to receive the finished brew, the inner container having a lower cap removeably affixed to a bottom end of the inner container, the lower cap having a orifice therethrough, the orifice having a piercing tip to puncture a brewing cup, the inner container having a groove positioned around an outer perimeter edge to receive a seal ring, an outer container to receive hot water, the outer container configured to receive the inner container, the lower cap, and the seal ring in a plunger sliding motion, wherein liquid is pressurized by downward force of inner container pushing liquid through orifice, through brewing capsule, and pushing brewed beverage into inner container.

### FIELD OF THE DISCLOSURE

The present disclosure is directed to hot brewed beverage apparatus. More specifically, the present disclosure is directed to portable and self-contained hot beverage brewing apparatus and container.

### BACKGROUND

Many people enjoy hot or cold brewed beverages, such as coffee, throughout their day. Hot brewed beverages such as coffee and tea have been around for a long time. A variety of brewing methods exist that expose coffee or tea grounds to heated water (brewed/mixed beverage) to extract the flavor of the grind into the water to create a coffee or tea liquid beverage. Coffee and tea is brewed in typically four main processes depending on how the water is introduced to the grounds: decoction (through boiling), infusion (through steeping), gravitational feed (used with percolators and in drip brewing), or pressurized percolation (as with espresso). To obtain the beverage one requires access to a beverage brewing machine and a cup/glass. Typical beverage brewing systems are inconvenient to use since they are generally stationary.

One prior approach of a counter top in office or in home single-cup brewing system was Keurig who introduced an office brewing system using K-Cup pods, which are single-serve coffee and their proprietary machines that brew the beverages in these pods. One disadvantage or drawback to this approach is that the Keurig or other like systems are not portable and require electric or batter power or other power source to complete the brewing process.

Another prior approach is cafetière, or French press. This method utilizes a tall, narrow cylinder with a plunger and a filter. The grounds are placed in the cylinder and hot water is then poured into it. The coffee and hot water are left in the cylinder for a few minutes and then the plunger is gently pushed down, pressing the water/coffee through the grounds and through the filter into the container below leaving the grounds in the filter immediately above. One disadvantage or drawback to this approach is that it is messy to clean up, if the grind is to fine for the filter the press can be physically difficult, and this method is an inefficient method of completing the brewing process.

Therefore, it is readily apparent that there is a recognizable unmet need for a web air threading system and methods of use that may be configured to address at least some aspects of the problems discussed above common to rethreading the paper web via nozzles and chutes.

### SUMMARY

Briefly described, in an example embodiment, the present disclosure may overcome the above-mentioned disadvantages and may meet the recognized need for a portable self-contained beverage brewing apparatus and methods of use to brew a beverage using a brewing cup, utilizing an inner cup/container/cylinder to receive the finished brew, the inner cup/container/cylinder having a lower cap removeably affixed to a bottom end of the inner cup/container/cylinder, the lower cap having a passageway/aperture/orifice therethrough, the passageway/aperture/orifice having a piercing tip to puncture a brewing cup, the inner cup/container/cylinder having a seal/ring groove positioned around an outer perimeter edge to receive a seal/ring, an outer cup/container/cylinder to receive hot water, the outer cup/container/cylinder configured to receive the inner cup/container/cylinder, the lower cap, and the seal/ring in a piston/plunger friction/seal slide, wherein hot water is pressurized by downward force of inner cup/container/cylinder pushing hot water through passageway/aperture/orifice, through brewing capsule, and pushing brewed beverage into inner cup/container/cylinder and, thus, functions to provide portable self-contained beverage brewing apparatus to brew and hold brewed beverage for consumption on the go.

Accordingly, in another aspect, the present disclosure of a passageway/aperture may include a one-way valve to enable brewed beverage to travel in one direction and prevent the brewed beverage from returning to the outer cup/container/cylinder.

Accordingly, in another aspect, the present disclosure may include a heating element integrated into the base of the outer cup/container/cylinder and power cord connected thereto to heat the water and stay behind as a base unit while the inner cup become a travelling brewed beverage container.

Accordingly, in another aspect, the present disclosure, may include an upper cap to seal the brewed beverage therein inner cup/container/cylinder for transport of the brewed beverage therein inner cup/container/cylinder.

In an exemplary embodiment of the portable self-contained beverage apparatus for mixing a brewing liquid with a mixture in a beverage brewing capsule to mix a brewed beverage, includes an inner container having a first inner container end and a second inner container end, each with open ends, an outer container having a first outer container end and a second outer container end, said first outer container end having an open end to receive said inner container and said second outer container end having an closed end, and a lower cap having a lower cap top and a lower cap sidewall configured to releasably attach to said first inner container end to hold the beverage brewing capsule in said inner container, said lower cap top having a brewing orifice formed therein as a passageway through said lower cap top to enable the brewing liquid to flow from said outer container through said brewing orifice, into the beverage brewing capsule to mix the mixture with the brewing liquid, and flow to said inner container as the brewed beverage, wherein said outer container and said inner container are configured to create a seal as inner container traverses therein and proximate said outer container to pressurize the brewing liquid.

In another exemplary embodiment of the portable self-contained beverage system for mixing a brewing liquid with a mixture to mix a brewed beverage, including an inner container having a first inner container end and a second inner container end, each with open ends, an outer container having a first outer container end and a second outer container end, said first outer container end having an open end to receive said inner container and said second outer container end having an closed end, and a lower cap having a lower cap top and a lower cap sidewall configured to releasably attach to said first inner container end to hold a beverage brewing capsule in said inner container, said lower cap top having a brewing orifice formed therein as a passageway through said lower cap top to enable the brewing liquid to flow from said outer container through said brewing orifice, into said beverage brewing capsule to mix the mixture contained therein with the brewing liquid, and flow to said inner container as the brewed beverage, wherein said outer container and said inner container are configured to create a seal as inner container traverses therein and proximate said outer container to pressurize the brewing liquid.

In another exemplary embodiment of a method of mixing a brewing liquid with a mixture to mix a brewed beverage via providing a self-contained mixing, said method including the steps of providing an inner container having a first inner container end and a second inner container end, each with open ends, an outer container having a first outer container end and a second outer container end, said first outer container end having an open end to receive said inner container and said second outer container end having an closed end, a lower cap having a lower cap top and a lower cap sidewall configured to releasably attach to said first inner container end to hold a beverage brewing capsule in said inner container, said lower cap top having a brewing orifice formed therein as a passageway through said lower cap top to enable the brewing liquid to flow from said outer container through said brewing orifice, into said beverage brewing capsule to mix the mixture contained therein with the brewing liquid, and flow to said inner container as the brewed beverage, wherein said outer container and said inner container are configured to create a seal as inner container traverses therein and proximate said outer container to pressurize the brewing liquid, filling said outer container with the brewing liquid, inserting said beverage brewing capsule into said first inner container end, attaching said lower cap to said first inner container end, inserting said first inner container end into said outer container opening, plunging said inner container into said outer container to pressurize the brewing liquid, pushing the brewing liquid through said brewing orifice into said beverage brewing capsule, mixing the brewing liquid with the mixture in said beverage brewing capsule, and forcing the brewing liquid and mixture in said beverage brewing capsule into said inner container.

A feature of the present disclosure may include enabling brewing of a hot or cold beverage while on the go.

A feature of the present disclosure may include providing a portable system that does not require a messy cleanup of grounds or grounds residue from the device.

A feature of the present disclosure may include an efficient method of brewing a tasty hot or cold beverage for consumption while on the go.

A feature of the present disclosure may include no requirement to power the apparatus by electricity or heat limiting their use to locations with a power source.

A feature of the present disclosure may include a self-contained beverage brewing apparatus.

A feature of the present disclosure may include enabling remote brewing for consumption while on the go.

A feature of the present disclosure may include no disassembly of apparatus is required to enjoy a freshly brewed beverage.

These and other features of the a portable self-contained beverage brewing apparatus and methods of use will become more apparent to one skilled in the art from the prior Summary and following Brief Description of the Drawings, Detailed Description of exemplary embodiments thereof, and Claims when read in light of the accompanying Drawings or Figures.

### BRIEF DESCRIPTION OF THE DRAWINGS

The present disclosure will be better understood by reading the Detailed Description of the Preferred and Selected Alternate Embodiments with reference to the accompanying drawing Figures, in which like reference numerals denote similar structure and refer to like elements throughout, and in which:

FIG. 1A is a top perspective view of the inner container of the portable self-contained beverage brewing apparatus according to select embodiments of the instant disclosure;

FIG. 1B is a top perspective view of the outer container of the portable self-contained beverage brewing apparatus according to select embodiments of the instant disclosure

FIG. 2A is a top perspective view of the lower cap of the portable self-contained beverage brewing apparatus according to select embodiments of the instant disclosure;

FIG. 2B is a side perspective view of the lower cap of the portable self-contained beverage brewing apparatus according to select embodiments of the instant disclosure;

FIG. 2C is a top perspective view of the seal ring of the portable self-contained beverage brewing apparatus according to select embodiments of the instant disclosure;

FIG. 3 is a top perspective view of the upper cap of the portable self-contained beverage brewing apparatus according to select embodiments of the instant disclosure;

FIG. 4 is a top perspective view of a beverage brewing capsule for use in portable self-contained beverage brewing apparatus of FIGS. 1-3 according to select embodiments of the instant disclosure;

FIG. 5 is a top perspective view of an assembly order of portable self-contained beverage brewing apparatus of FIGS. 1-3 according to select embodiments of the instant disclosure;

FIG. 6 is a flow diagram depicting assembly and operation of portable self-contained beverage brewing apparatus.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

In describing the exemplary embodiments of the present disclosure, as illustrated in the figures specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

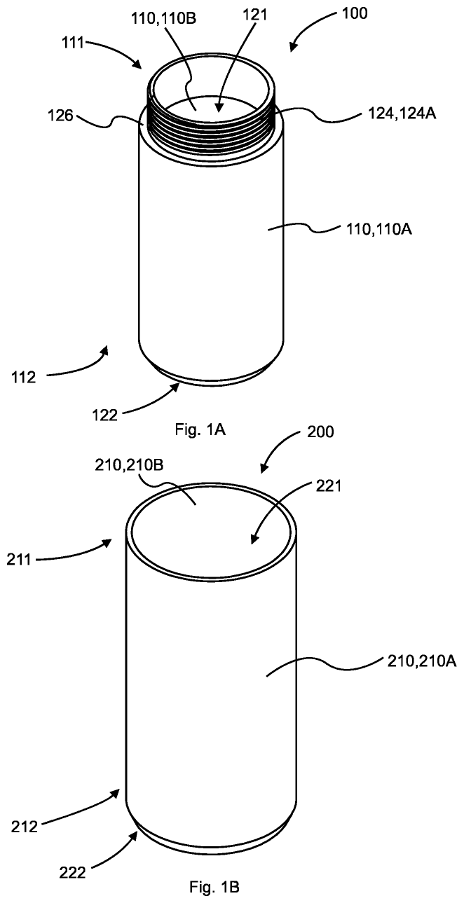

Referring now to FIGS. 1A and 1B, by way of example, and not limitation, there is illustrated an example embodiment of inner and outer containers of portable self-contained beverage brewing apparatus 10, according to this select embodiment. Inner container 100 may be configured as a tube 110 with outer surface 110A and inner surface 110B and having first inner container end 111 and second inner container end 112 with preferably open ends, such as first inner container opening 121 for first inner container end 111 and second inner container opening 122 for second inner container end 112 to form tube 110. Moreover, first inner container end 111 may be machined to form circular or perimeter ledge 126 therearound first inner container end 111. Furthermore, first inner container end 111 may be threaded 124 with first thread set 124A therearound first inner container end 111 to receive a threaded end.

Outer container 200 may be configured as an outer sleeve or surface 210 with outer surface 210A and inner surface 210B and having first outer container end 211 and second outer container end 212 with preferably one open end and one closed end to form a container, such as outer container opening 221 for first outer container end 211 to receive inner container 100 and outer container closed end 222 for second outer container end 212 to form outer container 200 and hold inner container 100 therein.

It is contemplated herein that second outer container end 212 or container closed end 222 may include a heating element to enable heating of fluid therein outer container 200 and such heating element may be powered by a variety of power sources, AC, DC or the like.

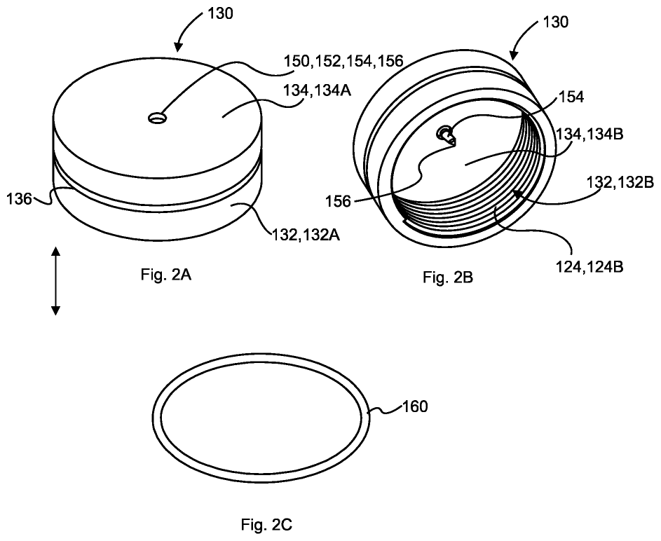

Referring now to FIGS. 2A, 2B and 2C, by way of example, and not limitation, there is illustrated an example embodiment of lower cap and seal of portable self-contained beverage brewing apparatus 10, according to this select embodiment. Lower cap 130 may be configured having lower cap top 134 with top outer surface 134A and top inner surface 134B preferably formed with lower cap sidewall 132 with sidewall outer surface 132A and sidewall inner surface 132B and dimensioned to fit or releasably attach therearound first inner container end 111. Furthermore, sidewall inner surface 132B may be threaded 124 with second thread set 124B to receive and rotationally engage first thread set 124A therearound first inner container end 111 to removeably attach lower cap 130 to first inner container end 111 and more specifically to contain beverage brewing capsule therein inner container 100.

Moreover, sidewall outer surface 132A of lower cap 130 may have one or more grooves 136 formed or machined therearound sidewall outer surface 132A to receive one or more, matching o-ring, such as seal ring 160 therearound to form a tight seal when inner container 100 and lower cap 130 plunge or pass therethrough the inside of outer container 200 proximate inner surface 210B.

It is contemplated herein that inner container 100, lower cap top 134, cap sidewall 132, and inner surface 210B of outer container 200 may be configured to create a tight seal as cylindrical cap sidewall 132 of inner container 100 traverses or plunges proximate cylindrical inner surface 210B of outer container 200 in a sealed piston arrangement through the length of outer container 200, such as cylindrical mating surfaces, however, other mating surfaces are contemplated herein.

Furthermore, lower cap top 134 may be configured with one or more brewing orifice 150 forming a passageway through lower cap top 134 to enable brewing liquids to flow from outer container 200 through brewing orifice 150 and into inner container 100 when inner container 100 is plunged therein outer container 200 of portable self-contained beverage brewing apparatus 10. The pressing of inner container 100 into outer container 200 hydraulically drives the fluid through brewing orifice 150 and into inner container 100.

Still furthermore, each brewing orifice 150 may be configured having a check vale, such as one-way valve 152 to enable brewing liquids to pass therethrough or flow in one direction from outer container 200 through brewing orifice 150 and into inner container 100.

Still furthermore, each brewing orifice 150 may be configured having brewing orifice tube 154 and further may include pointed tip 156 to further assist brewing liquids to pass therethrough or flow from outer container 200 through brewing orifice 150 and into inner container 100 and to puncture top surface 434.

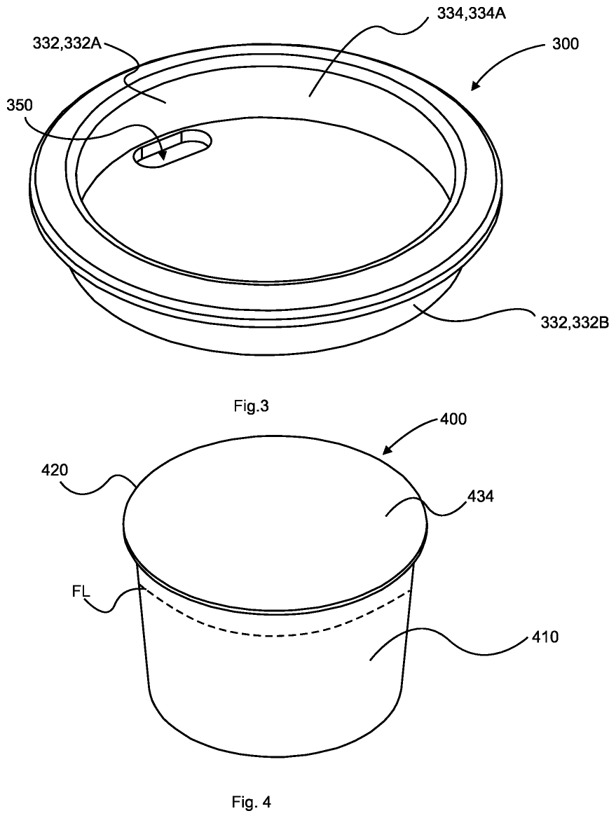

Referring now to FIG. 3, by way of example, and not limitation, there is illustrated an example embodiment of upper cap of portable self-contained beverage brewing apparatus 10, according to this select embodiment. Upper cap 300 may be configured having upper cap top 334 with top outer surface 334A and top inner surface 334B preferably formed with cap sidewall 332 with sidewall outer surface 332A and sidewall inner surface 332B and dimensioned to fit therein second inner container end 112 of inner container 100 or first outer container end 211 of outer container 200 to seal the top of either container to keep the beverage from spilling.

It is contemplated herein that upper cap 300 may be friction fit to second inner container end 112 of inner container 100 or first outer container end 211 of outer container 200 or threaded or other ways to connect and hold upper cap 300 to second inner container end 112 of inner container 100 or first outer container end 211 of outer container 200.

It is contemplated herein that upper cap top 334 may contain an aperture, such as fluid passage hole 350 to allow brewed beverage to pass through and be consumed or poured by a user. Moreover, upper cap 300 may be used as a lid to keep brewed beverage or hot fluid from spilling out of inner container 100 or outer container 200.

It is contemplated herein that fluid passage hole 350 may be may be operable between an open aperture and a closed aperture to open the fluid passage for drinking the brewed beverage and for venting inner container 100 during brewing operation.

Referring now to FIG. 4, by way of example, and not limitation, there is illustrated an example embodiment of beverage brewing capsule of portable self-contained beverage brewing apparatus 10, according to this select embodiment. Beverage brewing capsule 400 may be configured having container 410 with an upper rim top 420. Upper rim top 420 may include top surface 434 to seal in a brewing base, such as coffee, tea, flavorings, plant juices, powders, nutraceuticals, pharmacies, remedies, medications, or the like mixtures (mixture).

It is contemplated herein that top surface 434 may be punctured by brewing orifice tube 154 and/or pointed tip 156 to assist brewing liquids to pass therethrough or flow from outer container 200 through brewing orifice 150 and into inner container 100.

Top surface 434 and top inner surface 334B preferably formed with cap sidewall 332 with sidewall outer surface 332A and sidewall inner surface 332B and dimensioned to fit therein second inner container end 112 of inner container 100 or first outer container end 211 of outer container 200 to seal the top of either container to keep the beverage from spilling.

It is contemplated that a separate tool may be used or affixed to portable self-contained beverage brewing apparatus 10 to puncture top surface 434 of beverage brewing capsule 400.

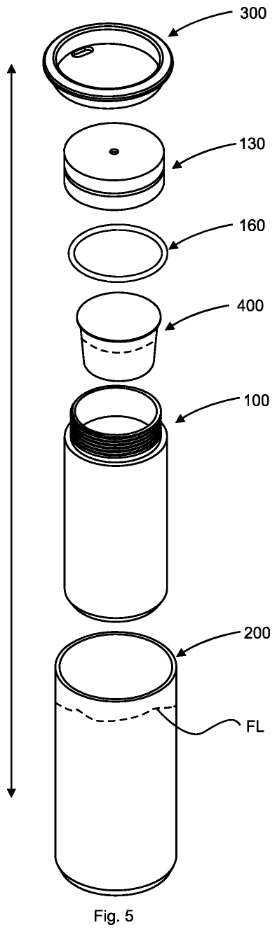

Referring now to FIG. 5, by way of example, and not limitation, there is illustrated an example embodiment of lower cap and seal of portable self-contained beverage brewing apparatus 10, according to this select embodiment. In use, outer container 200 may be filled with brewing liquid, such as brewing fluid FL, which may be hot water, carbonated water, cold water, iced water, adult beverage, or other like brewing medium (brewing liquid). Beverage brewing capsule 400 may be inserted into first inner container opening 121 of inner container 100 and lower cap 130 with seal ring 160 positioned in groove 136 may be threaded or fastened to attach lower cap 130 to first inner container end 111 and puncture top surface 434 of beverage brewing capsule 400. Inner container 100 may be inverted and second inner container end 112 may be inserted into outer container opening 221 of outer container 200. Inner container 100 may be plunged or forced in a piston movement with seal ring 160 sealed to facilitate pressurizing (pressurize) brewing fluid FL by downward force of inner container 100 pushing brewing fluid FL from outer container 200 through brewing orifice 150, orifice tube 154, and or pointed tip 156 to allow brew to flow into beverage brewing capsule 400 and then flow to inner container 100 of portable self-contained beverage brewing apparatus 10. Moreover, brewing fluid FL enters beverage brewing capsule 400 and mixes or brews brewing fluid FL with contents/mixture contained or held in beverage brewing capsule 400. Mixed or brewed brewing fluid FL and contents of beverage brewing capsule 400 (brewed/mixed beverage) flow into inner container 100 as a beverage ready for consumption. Alternatively, upper cap 300 may be fitted to second inner container end 112 of inner container 100 or first outer container end 211 of outer container 200 to keep the brew fresh and help maintain temperature for a duration. Furthermore, brew may be consumed through fluid passage hole 350 of upper cap 300.

It is contemplated herein that portable self-contained beverage brewing apparatus 10 components may be constructed of stainless steel, aluminum, or the like materials and of different dimensions. This and other materials herein may be constructed of metal, steel, alloy, or plastic or more specifically high density polyethylene or similar high tensile or strengthened materials, as these material offers a variety of forms and shapes and provide strength with reduced weight; however, other suitable materials or the like, can be utilized, provided such material has sufficient strength and/or durability as would meet the purpose described herein.

It is understood herein that various changes in the material used, shape, size, arrangement of parts, and parts are removeably connected with threads, or other rotating devices without departing from the spirit of the scope of the claims herein.

It is further understood herein that the parts and elements of this disclosure may be located or position elsewhere based on one of ordinary skill in the art without deviating from the present disclosure.

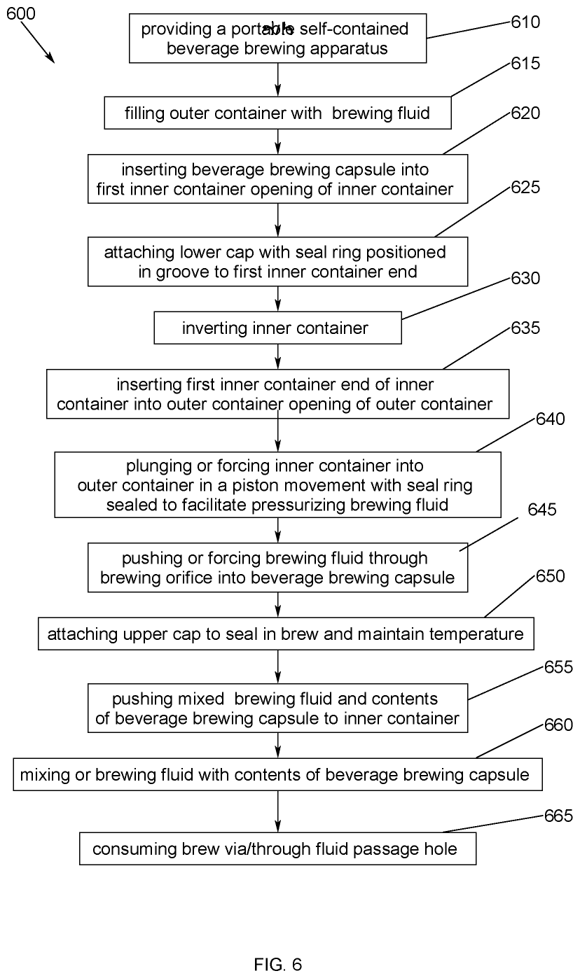

Referring now to FIG. 6, there is illustrated a flow diagram 600 of a method of assembly and operation of portable self-contained beverage brewing apparatus 10. In block or step 610, providing portable self-contained beverage brewing apparatus 10, as described above in FIGS. 1-5, to enable portable self-contained beverage brewing. In block or step 615, filling outer container 200 with brewing fluid FL. In block or step 620, inserting beverage brewing capsule 400 into first inner container opening 121 of inner container 100. In block or step 625, attaching lower cap 130 with seal ring 160 positioned in groove to first inner container end 111. In block or step 630, inverting inner container 100. In block or step 635, inserting first inner container end 111 of inner container 100 into outer container opening 221 of outer container 200.

In block or step 640 plunging or forcing inner container 100 into outer container 200 in a piston movement with seal ring 160 sealed to facilitate pressurizing brewing fluid FL. In block or step 645, pushing or forcing brewing fluid FL through brewing orifice 150, orifice tube 154, and or pointed tip 156 into beverage brewing capsule 400 and portable self-contained beverage brewing apparatus 10. In block or step 650, mixing or brewing fluid FL with contents of beverage brewing capsule 400 (brewed/mixed beverage). In block or step 655, pushing or forcing mixed or brewed brewing fluid FL and contents/mixture of beverage brewing capsule 400 (brewed/mixed beverage) into/to inner container 100 as a beverage ready for consumption. In block or step 660, attaching upper cap 300 to second inner container end 112 of inner container 100 or first outer container end 211 of outer container 200 to seal and keep the brew fresh and help maintain temperature for a duration. In block or step 665, consuming brew via/through fluid passage hole 350 of upper cap 300 or from rim of inner container 100 or outer container 200.

With respect to the above description then, it is to be realized that the optimum dimensional relationships, to include variations in size, materials, shape, form, position, movement mechanisms, function and manner of operation, assembly and use, are intended to be encompassed by the present disclosure.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Moreover, the present disclosure has been described in detail, it should be understood that various changes, substitutions and alterations can be made thereto without departing from the spirit and scope of the disclosure as defined by the appended claims. Accordingly, the present disclosure is not limited to the specific embodiments illustrated herein but is limited only by the following claims.

1. A portable self-contained beverage apparatus for mixing a brewing liquid with a mixture in a beverage brewing capsule to mix a brewed beverage, said apparatus comprising:
an inner container having a first inner container end and a second inner container end, each with open ends;
an outer container having a first outer container end and a second outer container end, said first outer container end having an open end to receive said inner container and said second outer container end having an closed end; and
a lower cap having a lower cap top and a lower cap sidewall configured to releasably attach to said first inner container end to hold the beverage brewing capsule in said inner container, said lower cap top having a brewing orifice formed therein as a passageway through said lower cap top to enable the brewing liquid to flow from said outer container through said brewing orifice, into the beverage brewing capsule to mix the mixture with the brewing liquid, and flow to said inner container as the brewed beverage,
wherein said outer container and said inner container are configured to create a seal as inner container traverses therein and proximate said outer container to pressurize the brewing liquid.

2. The apparatus of claim 1, wherein said first inner container end having a perimeter ledge therearound.

3. The apparatus of claim 1, wherein said first inner container end is threaded with a first thread set.

4. The apparatus of claim 3, wherein said lower cap sidewall is threaded with a second thread set to rotationally engage said first thread set to removeably attach said lower cap to said first inner container end.

5. The apparatus of claim 1, wherein said second outer container end further comprises a heating element to heat the brewing liquid in said outer container.

6. The apparatus of claim 1, wherein said lower cap sidewall further comprises a groove therearound.

7. The apparatus of claim 6, wherein said groove is configured to receive a seal ring to create a seal between said outer container and said inner container.

8. The apparatus of claim 1, wherein said lower cap sidewall further comprises a seal therearound.

9. The apparatus of claim 1, wherein said brewing orifice further comprises a one-way valve.

10. The apparatus of claim 1, wherein said brewing orifice further comprises a brewing orifice tube.

11. The apparatus of claim 10, wherein said brewing orifice tube further comprises a pointed tip to puncture the beverage brewing capsule.

12. A portable self-contained beverage system for mixing a brewing liquid with a mixture to mix a brewed beverage, said system comprising:
an inner container having a first inner container end and a second inner container end, each with open ends;
an outer container having a first outer container end and a second outer container end, said first outer container end having an open end to receive said inner container and said second outer container end having an closed end; and
a lower cap having a lower cap top and a lower cap sidewall configured to releasably attach to said first inner container end to hold a beverage brewing capsule in said inner container, said lower cap top having a brewing orifice formed therein as a passageway through said lower cap top to enable the brewing liquid to flow from said outer container through said brewing orifice, into said beverage brewing capsule to mix the mixture contained therein with the brewing liquid, and flow to said inner container as the brewed beverage,
wherein said outer container and said inner container are configured to create a seal as inner container traverses therein and proximate said outer container to pressurize the brewing liquid.

13. The system of claim 12, wherein said first inner container end having a perimeter ledge therearound.

14. The system of claim 12, wherein said first inner container end is threaded with a first thread set.

15. The system of claim 14, wherein said lower cap sidewall is threaded with a second thread set to rotationally engage said first thread set to removeably attach said lower cap to said first inner container end.

16. The system of claim 12, wherein said second outer container end further comprises a heating element to heat the brewing liquid in said outer container.

17. The system of claim 12, wherein said lower cap sidewall further comprises a groove therearound.

18. The system of claim 17, wherein said groove is configured to receive a seal ring to create a seal between said outer container and said inner container.

19. The system of claim 1, wherein said lower cap sidewall further comprises a seal therearound.

20. The system of claim 12, wherein said brewing orifice further comprises a one-way valve.

21. The system of claim 12, wherein said brewing orifice further comprises a brewing orifice tube.

22. The system of claim 21, wherein said brewing orifice tube further comprises a pointed tip to puncture the beverage brewing capsule.

23. A method of self-contained mixing a brewing liquid with a mixture to mix a brewed beverage, said method comprising the steps of:
providing an inner container having a first inner container end and a second inner container end, each with open ends, an outer container having a first outer container end and a second outer container end, said first outer container end having an open end to receive said inner container and said second outer container end having an closed end, a lower cap having a lower cap top and a lower cap sidewall configured to releasably attach to said first inner container end to hold a beverage brewing capsule in said inner container, said lower cap top having a brewing orifice formed therein as a passageway through said lower cap top to enable the brewing liquid to flow from said outer container through said brewing orifice, into said beverage brewing capsule to mix the mixture contained therein with the brewing liquid, and flow to said inner container as the brewed beverage, wherein said outer container and said inner container are configured to create a seal as inner container traverses therein and proximate said outer container to pressurize the brewing liquid;
filling said outer container with the brewing liquid;
inserting said beverage brewing capsule into said first inner container end;
attaching said lower cap to said first inner container end;
inserting said first inner container end into said outer container opening;
plunging said inner container into said outer container to pressurize the brewing liquid;
pushing the brewing liquid through said brewing orifice into said beverage brewing capsule;
mixing the brewing liquid with the mixture in said beverage brewing capsule; and
forcing the brewing liquid and mixture in said beverage brewing capsule into said inner container.
